(19) United States
(12) Patent Application Publication
(10) Pub. No.: US 2007/0277793 A1
(43) Pub. Date: Dec. 6, 2007

(54) Method for operating an internal combustion engine

(76) Inventor: Edward Lawrence Warren, West Melbourne, FI (US)

Correspondence Address: Edward L. Warren, 3912 Snowy Egret Dr., West Melbourne, FL, 32904, US

(21) Appl. No.: 11/443,689

(22) Filed: Jun. 1, 2006

(51) Int. Cl. F02B 33/00

(52) U.S. Cl. 123/563; 123/559.1; 123/565

(57) ABSTRACT

A method of operating a reciprocating, four stroke internal combustion piston engine system with an external compressor so that the air prior to internal compression is cooled, making it possible to attain a higher compression ratio. This can result in less heat input and the same work per stroke output, thereby saving fuel. Or it can result in more work per stroke output for the same heat input. A form of dynamic braking can be used with its operation. The only modifications to the engine are adding an external compressor, increasing the internal compression ratio, and changing the timing of the inlet valve closing.

### BACKGROUND

1. Field of Invention

The most popular internal combustion engines in use today are the Otto cycle and the Diesel cycle. These cycles are similar, and are very good engines that have been in use for over one hundred years. There have been numerous attempts to improve on the mechanics of the engine, but the basic cycle has not been modified. There is a need to make engines use less fuel, but the engines are already near the maximum thermal efficiency possible; therefore, in addition to making an engine with a cycle that is more efficient it is necessary to make the engine capable of using known techniques for getting more mileage out of the existing engines.

These known techniques are: external compression, higher compression ratio, and saving the braking energy using a form of dynamic braking.

2. Description of Prior Art

The highest efficiency for the present four stroke internal combustion piston engines is at the highest compression ratio that is practical.

The present four stroke internal combustion piston engines have braking by compressing air but they do not use the energy of braking. They also have external compression in the form of super-charging, but they do not make the most use of the external compression.

The present four stroke internal combustion piston engines need better expansion of the charge to make the engine more efficient. U.S. Pat. No. 6,341,585 to Warren (2002) is a method for making present four stroke internal combustion piston engines have better expansion of the charge. This is accomplished by delaying inlet valve closing so that some of the charge is pushed back out of the engine.

Most of the engines can brake the load by compressing air. What is needed is an engine that stores and uses the resulting compressed air.

U.S. Pat. No. 5,179,839 to Bland (1993), U.S. Pat. No. 4,817,388 to Bland (1989), and patent application Ser. No. 10/867332 to Warren (2004) can do some of the above, but they require extensive modification to the engine. What is needed is a way to do the above with minor modification to the engine.

### SUMMARY

The present invention is a method of operating a reciprocating, four stroke internal combustion piston engine system with an external compressor so that the air prior to internal compression is cooled, making it possible to attain a higher compression ratio. This can result in less heat input and the same work per stroke output, thereby saving fuel. Or it can result in more work per stroke output for the same heat input. A form of dynamic braking can be used with its operation. The only modifications to the engine are adding an external compressor, increasing the internal compression ratio, and changing the timing of the inlet valve closing.

This is not a supercharged engine. A supercharged engine increases the amount of air entering the engine. The present invention does not increase the amount of air flowing through the engine. The present invention can be supercharged.

### OBJECTS AND ADVANTAGES

The present invention has the following advantages:

It saves fuel.

It can be made with off the shelf compressors, and engines. (Some parts in the engine would have to be modified.)

It operates on a very efficient thermodynamic cycle.

### DRAWING FIGURES

FIG. 1 shows the preferred embodiment of the invention. It is a commercially available engine system with power take off 22, compressor 4, and cooler 5 added.

FIG. 2 shows the operation of modified four stroke internal combustion piston engine 8.

FIG. 3 shows the first alternate embodiment of the invention. It is a commercially available engine system with power take off 22, compressor 4, cooler 5, tank 6, compressed air pressure regulator 16, and engine clutch 30 added.

### REFERENCE NUMERALS IN DRAWINGS

2 air inlet
4 compressor
5 cooler
6 tank
8 four stroke internal combustion piston engine
10 exhaust
12 cylinder
14 power piston
16 compressed air pressure regulator
18 inlet valve
20 power output shaft
22 power take off
24 exhaust valve
26 inlet valve lobe
28 exhaust valve lobe
30 engine clutch
32 cam shaft
34 clearance volume
40 load
46 fuel injector
48 igniter

### DESCRIPTION—PREFERRED EMBODIMENT

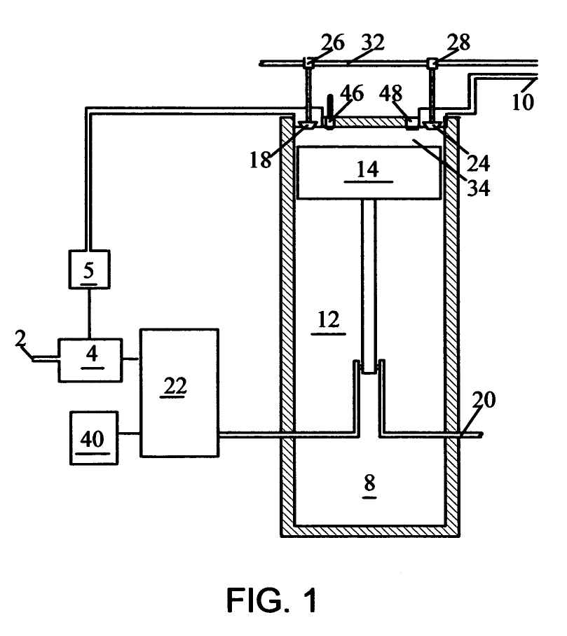

The preferred embodiment of the engine system is shown in FIG. 1. It is air inlet 2, compressor 4, cooler 5, power take off 22, load 40, and one or more modified four stroke internal combustion piston engines 8, which is a commercially available engine comprising exhaust 10, cylinder 12, power piston 14, inlet valve 18, power output shaft 20, exhaust valve 24, inlet valve lobe 26, exhaust valve lobe 28, cam shaft 32, clearance volume 34, fuel injector 46, and igniter 48.

Power output shaft 20 drives power take off 22, and load 40.

Compressor 4, power take off 22, and cooler 5 supply compressed air at ambient temperature to modified four stroke internal combustion piston engine 8. Power take off 22 is the power transfer means for driving compressor 4. Power take off 22 can be a transmission and clutch, a variable speed transmission, a continuously variable speed transmission, or a generator, battery and motor.

“Ambient weight air” is the weight of the amount of air in unmodified four stroke internal combustion piston engine 8 immediately prior to compression when the air is at outside ambient conditions of temperature and pressure. This is not a supercharged engine. The air flow rate through modified four stroke internal combustion piston engine 8 is the same as the air flow rate through four stroke internal combustion piston engine 8 before it was modified.

Inlet valve lobe 26 on cam shaft 32 opens and closes inlet valve 18. Both modified inlet valve lobe 26 and unmodified inlet valve lobe 26 open inlet valve 18 when power piston 14 is at the top of its stoke. Modified Inlet valve lobe 26 on cam shaft 32 is modified so that inlet valve 18 closes when a quantity of air enters cylinder 12 approximately equal to ambient weight air.

The closing of inlet valve 18 catches a volume of ambient temperature compressed air. As power piston 14 moves down the compressed air expands and cools. This allows a higher compression ratio to be used. The amount of higher compression ratio is dependent on the external pressure ratio, and the operating requirements of the load. The higher the external pressure ratio the higher the compression ratio can be. An approximate higher compression ratio could be one that produces the same work per stroke at modified four stroke internal combustion piston engine 8's maximum temperature with less heat input, hence less fuel, than the unmodified four stroke internal combustion piston engine 8 operating at its maximum temperature.

Modified four stroke internal combustion piston engine 8 can be supercharged.

The preferred embodiment of the engine system can have one or more modified four stroke internal combustion piston engines 8.

### OPERATION—PREFERRED EMBODIMENT

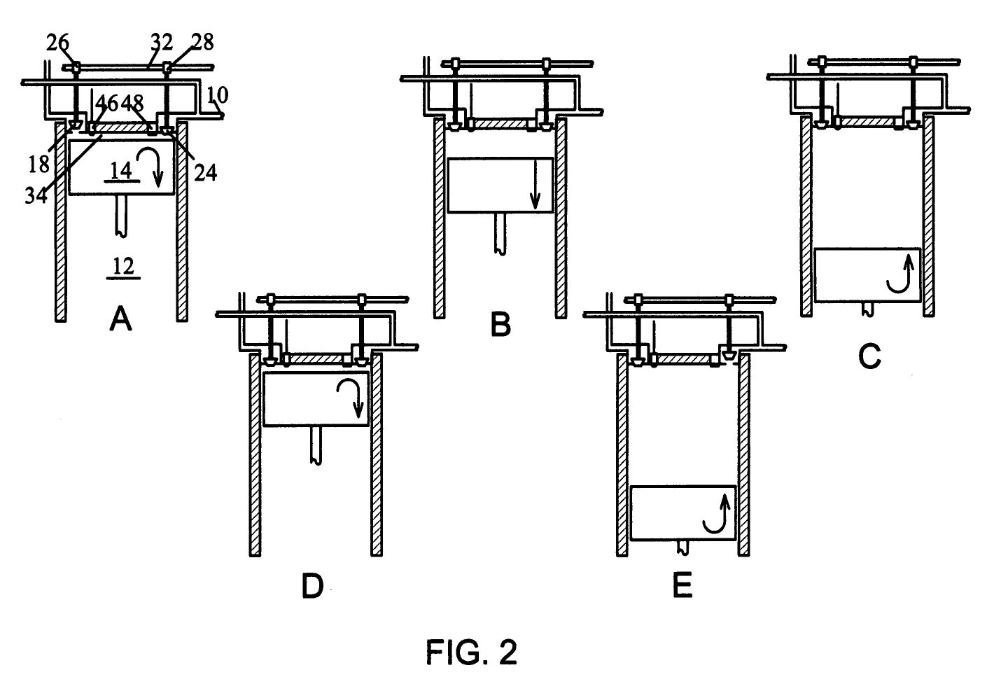

In FIG. 1 air enters at air inlet 2, is compressed by compressor 4, is cooled by cooler 5, then the compressed air enters modified four stroke internal combustion piston engine 8. FIG. 2 shows the operation of modified four stroke internal combustion piston engine 8. Between FIGS. 2A and 2B power piston 14 moves down, and air enters cylinder 12. At FIG. 2B inlet valve 18 closes when a quantity of air enters cylinder 12 equal to ambient weight air. Between FIGS. 2B and 2C power piston 14 moves down and the compressed air expands and cools. At FIG. 2C power piston 14 is at the bottom of its travel. Between FIGS. 2C and 2D power piston 14 moves up, the air in cylinder 12 is compressed. In FIG. 2D, at the top of power piston 14's stroke, fuel is added by fuel injector 46, and igniter 48 causes ignition to take place. Between FIGS. 2D and 2E expansion and power output takes place. In FIG. 2E exhaust valve 24 opens. Between FIGS. 2E and 2A exhausting takes place through exhaust valve 24. In FIG. 2A, at the top of power piston 14's stroke, exhaust valve 24 closes and inlet valve 18 opens. The cycle repeats.

### Description—First Alternate Embodiment

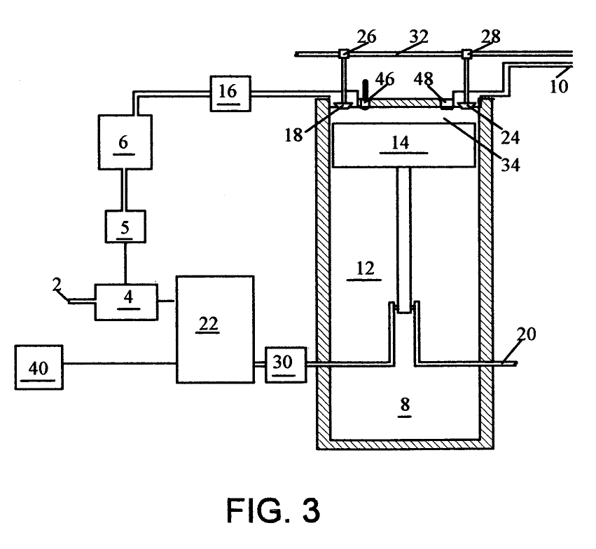

The first alternate embodiment of the engine system is shown in FIG. 3. It comprises air inlet 2, compressor 4, cooler 5, tank 6, compressed air pressure regulator 16, power take off 22, engine clutch 30, load 40, and modified four stroke internal combustion piston engine 8, which is a commercially available engine comprising exhaust 10, cylinder 12, power piston 14, inlet valve 18, power output shaft 20, exhaust valve 24, inlet valve lobe 26, exhaust valve lobe 28, cam shaft 32, clearance volume 34, fuel injector 46, and igniter 48.

Compressor 4, power take off 22, cooler 5, tank 6, and compressed air pressure regulator 16 supply compressed air at ambient temperature to modified four stroke internal combustion piston engine 8. Power take off 22 is the power transfer means for driving said compressor. Power take off 22 can be a transmission and clutch, a variable speed transmission, a continuously variable speed transmission, or a generator, battery, and motor.

Inlet valve lobe 26 on cam shaft 32 opens and closes inlet valve 18. Inlet valve lobe 26 on cam shaft 32 is modified so that inlet valve 18 closes when a quantity of air enters cylinder 12 approximately equal to ambient weight air. This is not a supercharged engine.

The above modification to the inlet valve lobe 26 allows a higher compression ratio to be used; therefore modified four stroke internal combustion piston engine 8 is modified to operate at a higher compression ratio.

Engine clutch 30 transfers power from power output shaft 20 to load 40. (Engine clutch 30 can also be a torque converter.) When engine clutch 30 disengages power output shaft 20 from load 40, load 40 drives compressor 4 by means of power take off 22.

The first alternate embodiment of the engine system can have one or more modified four stroke internal combustion piston engines 8.

Modified four stroke internal combustion piston engine 8 can be supercharged.

### Operation—First Alternate Embodiment

In FIG. 3 air enters the engine system through air inlet 2 and moves into compressor 4 where it is compressed, then through cooler 5 where it is cooled to ambient, then into tank 6 where it is stored. The cooled compressed air then moves into modified four stroke internal combustion piston engine 8. Compressed air pressure regulator 16 controls the air pressure to modified four stroke internal combustion piston engine 8.

FIG. 2 shows the operation of modified four stroke internal combustion piston engine 8. Between FIGS. 2A and 2B power piston 14 moves down, and air enters cylinder 12. At FIG. 2B inlet valve 18 closes when a quantity of air enters cylinder 12 equal to ambient weight air. Between FIGS. 2B and 2C power piston 14 moves down and the compressed air expands and cools. At FIG. 2C power piston 14 is at the bottom of its travel. Between FIGS. 2C and 2D power piston 14 moves up, the air in cylinder 12 is compressed. In FIG. 2D, at the top of power piston 14's stroke, fuel is added by fuel injector 46, and igniter 48 causes ignition to take place. Between FIGS. 2D and 2E expansion and power output takes place. In FIG. 2E exhaust valve 24 opens. Between FIGS. 2E and 2A exhausting takes place through exhaust valve 24. In FIG. 2A, at the top of power piston 14's stroke, exhaust valve 24 closes and inlet valve 18 opens. The cycle repeats.

To brake modified four stroke internal combustion piston engine 8, engine clutch 30 disengages power output shaft 20 from load 40, load 40 drives compressor 4 by means of power take off 22. The pressure in tank 6 is raised during braking when compressed air that is not being used is stored.

Later, when used for operation, the air from tank 6 and compressed air pressure regulator 16 regulates the pressure of the air going into modified four stroke internal combustion piston engine 8. As long as there is adequate pressure in tank 6 more output per stroke occurs when power take off 22 reduces the power from modified four stroke internal combustion piston engine 8 driving compressor 4.

### CONCLUSION

The present invention has the big advantage that it only requires a slight modification of inlet valve lobe 26 on cam shaft 32 so that inlet valve 18 closes when a quantity of air enters cylinder 12 equal to ambient weight air. These causes modified four stroke internal combustion piston engine 8 to operate on a very efficient thermodynamic cycle, and allows operation with increased compression ratio, supercharging, and dynamic braking.

In addition, the present invention can be made with off the shelf compressors, and engines. (Some parts in the engine would have to be modified.)

I claim:

1. A modified four stroke internal combustion piston engine system comprising:
a) a compressor,
b) a power transfer means for driving said compressor,
c) a cooler,
d) one or more modified four stroke internal combustion piston engines,
e) said modified four stroke internal combustion piston engine comprising: a cylinder, a clearance volume, a power piston, a cam shaft, an inlet valve, an inlet valve lobe to open and close said inlet valve, an exhaust valve, an exhaust valve lobe to open and close said exhaust valve, a fuel injector, a power output shaft, and an igniter,
f) said inlet valve lobe modified so that said inlet valve opens at about the start of said power piston's intake stroke, and closes when a quantity of air enters said cylinder approximately equal to ambient weight air,
g) said compression ratio of said modified four stroke internal combustion piston engine is modified so that said modified four stroke internal combustion piston engine operates at a predetermined higher compression ratio,
h) a load connected to said power output shaft.

2. A method of operating a modified four stroke internal combustion piston engine system comprising:
a) a compressor,
b) a power transfer means for driving said compressor,
c) a cooler,
d) one or more modified four stroke internal combustion piston engines,
e) said modified four stroke internal combustion piston engine comprising: a cylinder, a clearance volume, a power piston, a cam shaft, an inlet valve, an inlet valve lobe to open and close said inlet valve, an exhaust valve, an exhaust valve lobe to open and close said exhaust valve, a fuel injector, a power output shaft, and an igniter,
f) said inlet valve lobe modified so that said inlet valve opens at about the start of said power piston's intake stroke, and closes when a quantity of air enters said cylinder approximately equal to ambient weight air,
g) said compression ratio of said modified four stroke internal combustion piston engine modified so that said modified four stroke internal combustion piston engine operates at a predetermined higher compression ratio,
h) a load connected to said power output shaft.
Said method of operating said modified four stroke internal combustion piston engine system comprising the steps of:
a) compressing ambient air,
b) cooling the resulting compressed air to near ambient temperature,
c) transferring said compressed air at ambient temperature into said cylinder of said modified four stroke internal combustion piston engine,
d) closing said inlet valve when a quantity of air enters said cylinder approximately equal to ambient weight air,
e) expanding and cooling said compressed air in said cylinder,
f) compressing said air in said cylinder,
g) adding heat to said air, now compressed air, in said cylinder by injecting and burning fuel,
h) expanding the products of combustion in said cylinder to produce power output,
i) exhausting said spent products of combustion to ambient,
j) repeating said steps.

3. A method of operating a modified four stroke internal combustion piston engine system comprising:
a) an engine clutch,
b) a compressor,
c) a power transfer means for diving said compressor,
d) a cooler,
e) a tank,
f) a compressed air pressure regulator,
g) a four stroke internal combustion piston engine comprising one or more modified four stroke internal combustion piston engines,
h) a load.
Said method of operating said modified four stroke internal combustion piston engine system comprising the steps of:
a) driving said load from said modified four stroke internal combustion piston engine through an engaged engine clutch,
b) braking said load by disengaging said engine clutch and driving said compressor through said power transfer means for driving said compressor,
c) cooling said air, now compressed,
d) storing said air, now compressed and cooled,
e) regulating the pressure of said compressed air as it comes out of said tank,
f) transferring said air, now compressed, to one or more of the said modified four stroke internal combustion piston engines.
